(19) United States
(12) Patent Application Publication
(10) Pub. No.: US 2013/0283960 A1
(43) Pub. Date: Oct. 31, 2013

(54) CONVERTER ARRANGEMENT FOR A MECHANICAL ACTUATOR

(71) Applicant: Peter Sieverding, Vechelde (DE)

(72) Inventor: Peter Sieverding, Vechelde (DE)

(73) Assignee: SIEMENS AKTIENGESELLSCHAFT, MUECHEN (DE)

(21) Appl. No.: 13/994,873

(22) PCT Filed: Dec. 9, 2011
(86) PCT No.: PCT/EP2011/072301

§ 371 Date: Jun. 17, 2013

(30) Foreign Application Priority Data
Dec. 16, 2010 (DE) 1020100632570

(51) Int. Cl. F16C 1/10

(52) U.S. Cl. CPC F16C 1/10
USPC 74/500.5

(57) ABSTRACT

An actuator has at least one mechanical activation device, to which at least one activation cable for activating field elements in the external system of the actuator is mounted. In order to implement such an actuator in a low-maintenance fashion, the activation cable is guided to a mechanical-electronic converter from which at least one electrical line leads to electronic systems of the field elements of the external system of the actuator.

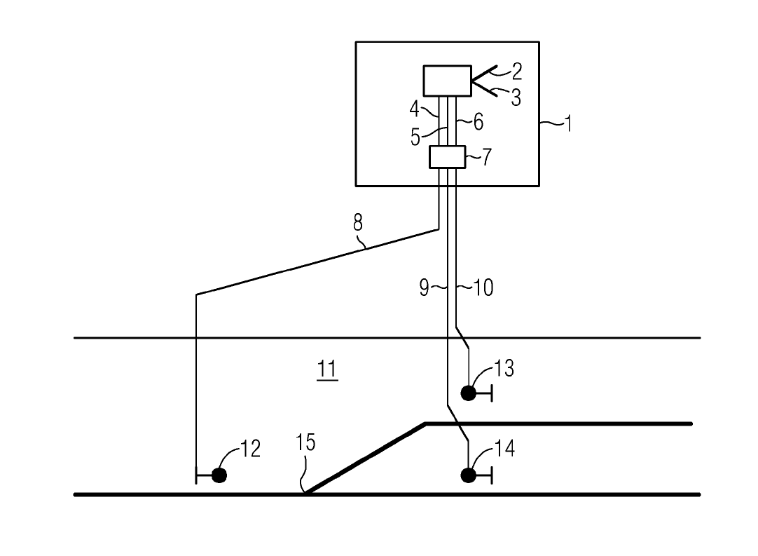

The invention relates to an actuator having at least one mechanical activation device, to which at least one activation cable for activating field elements in the external system of the actuator is mounted. Field elements are understood here to mean switches and signalling devices.

Such an actuator is generally known and a large number thereof is currently still in operation. With this known mechanical design of an actuator, activation cables embodied as steel cables are moved longitudinally by way of as a rule a number of activation devices in the form of levers, said activation cables being connected to switches and mechanical signalling devices in the external system of the actuator. The steel cables must undergo regular maintenance and be replaced, thereby being associated with significant costs.

The object underlying the invention is to propose an actuator, which is embodied so as to be comparatively low maintenance.

In order to achieve this object, with the actuator of the type specified in the introduction, the activation cable is inventively guided to a mechanical-electronic converter arrangement, from which at least one electrical line leads to electronic systems of field elements in the external system of the actuator.

One significant advantage of the inventive actuator is that it is to some extent structured semi-electronically by retaining essential mechanical elements of the internal system of a mechanical actuator, by the activation device remaining in the form of the levers and the activation cable also being used further to a small extent, engaging with the lever. A further advantage consists in only one mechanical-electronic converter arrangement being provided, from which at least one largely maintenance-free electrical line is guided to electronic systems of the field elements of the external system, such as switches and signalling devices. The retrofitting of the signalling devices and switches which is required for this purpose can in this respect be performed in a cost-effective manner since electronic systems from such field elements can be used in the process, as are conventionally in electronic actuators. An additional advantage consists in nothing changing from the perspective of the respective operating person of the actuator, because this operating person still also has the activation elements available to him/her as normal; special training in terms of the inventive actuator is therefore not required.

In an advantageous embodiment of the mechanical actuator according to the invention, the mechanical-electronic converter arrangement is accommodated in the internal system of the actuator, because then the activation cable can be not only advantageously short but is also protected against corrosion from atmospheric influences.

For further explanation of the invention, an exemplary embodiment of the inventive actuator which is shown schematically is shown in the FIGURE.

As apparent from the FIGURE, a number of activation elements 2 and 3 embodied as levers are accommodated in an internal system 1 of an actuator (otherwise not shown in further detail); the activation element 2 is shown here in its resting position, while the activation element 3 is activated; a further activation element cannot be identified. An activation cable 4, 5 and 6 in the form of a short steel cable piece leads from each of the three activation elements to a mechanical-electrical converter arrangement 7, which is likewise accommodated in the internal system so that the activation cables are protected against damaging environmental influences.

The mechanical-electronic converter arrangement 7 generates a signal S1, S2 and S3 as a function of the position of the activation cables 4, 5 and 6 effected by the activation devices. These signals S1, S2 and S3 are transmitted via an electric line 8, 9 10 in each instance into the external system 11 of the actuator and end at electronic systems (not shown in further detail) of signalling devices 12, 13 and 14 only shown schematically in the FIGURE.

Correspondingly, a switch 15 which is likewise only embodied schematically can be activated as a further field element by way of its electronic system.

Electronic components are considered as electronic systems, such as are used in electronic actuators.

1-2. (canceled)

3. An actuator, comprising:
an external system having field elements with electronic systems;
at least one mechanical activation device;
at least one activation cable for activating said field elements in said external system, said activation cable mounted to said mechanical activation device;
a mechanical-electronic converter connected to said activation cable; and
at least one electrical line connected between said electronic systems of said field elements of said external system and said mechanical-electronic converter.

4. The actuator according to claim 3, further comprising an internal system accommodating at least said mechanical-electronic converter.
